(19) United States
(12) Patent Application Publication
(10) Pub. No.: US 2011/0105117 A1
(43) Pub. Date: May 5, 2011

(54) Method And System Of Delivering An SMS Message

(76) Inventors: Frances M. Chin, Naperville, IL (US); John M. Gafrick, Naperville, IL (US)

(21) Appl. No.: 12/608,640

(22) Filed: Oct. 29, 2009

(51) Int. Cl. H04W 60/00; H04W 4/12; H04W 36/12

(52) U.S. Cl. 455/435.1; 455/466; 455/552.1

(57) ABSTRACT

A Mobile Switching Center (MSC) receives a short message service (SMS) message from a mobile station. The MSC checks a link between it and an MME to see if the link is currently set. If the link is not currently set, the mobile station is re-registered at the MSC, which re-established the link between the MSC and the MME. The mobile station will resend the SMS message to the MSC, which now utilizes the re-established link to deliver the SMS message.

### FIELD OF THE INVENTION

The present invention relates generally to communication systems, and more particularly to Short Message Service (SMS).

### BACKGROUND OF THE INVENTION

Short Message Service (SMS) has become a very popular feature in communication systems. Because SMS messages are not time-dependent, an acknowledgement message typically is not sent to the sender of an SMS message.

Currently, when a 3G Mobile Switching Center (MSC) receives an SMS message from a mobile station, if the state of the SGs interface between the 4G Long Term Evolution (LTE) MME and the 3G MSC is Null, the 3G MSC will ignore the SMS request. The 3G MSC will therefore not send a failure notification to the MME. Because the MME was not the original sender of the SMS message, the MME will not have set a timeout timer for the SMS message.

So in the above scenario, the sending mobile station will not receive a failure notification from the 3G MSC indicating that the SMS message was not delivered. In addition, the MME assumes that the association with the 3G-MSC for the mobile station is still alive and will continue to pass the mobile station originated SMS messages to the 3G-MSC. However, the MSC will continue to ignore the SMS requests. This situation can last up to several hours or longer without notices.

Therefore, a need exists for a method and system for reliably sending SMS messages from a mobile station when the state of the SGs interface between the 4G LTE MME and the 3G MSC is inoperative.

### BRIEF SUMMARY OF THE INVENTION

An exemplary embodiment of the present invention provides a method for re-registering a mobile station. The mobile station initiates an SMS message by sending an SMS message to an eNodeB. The mobile station may start a timeout timer to assist in resending the message should an acknowledgement message not be received in a timely manner.

The eNodeB passes the SMS message to an MME, which checks the SGs association with an MSC. If the SGs association between the MME and the MSC is active at the MME, the MME encapsulates the SMS message and sends it to the MSC.

In the situation where the SGs association on MSC between the MME and the MSC is not currently set, such as when a VLR record associated with the mobile station is deleted due to VLR overload control or other administrative reasons or the SGs association is equal to SGs-NULL, the MSC re-registers the mobile station. The re-registration re-establishes an SGs association at the MSC between the MSC and the MME.

Upon expiration of the timeout timer, the mobile station resends the SMS message. Alternately, the SMS message can be stored during registration at the MSC and resent by the MSC once registration is complete. In this alternate embodiment, the mobile station would not need to start a timeout timer or resend the SMS message.

The eNodeB passes the SMS message to the MME, which encapsulates the SMS message and sends it to the MSC.

The MSC checks the SGs association between it and the MME. Since the MSC re-registered the mobile station and re-established an SGs association between the MSC and the MME, the MSC acknowledges the receipt of the SMS message with an Ack message. The MME passes the acknowledgement to the eNodeB via a downlink Ack message. The eNodeB passes the acknowledgement to the mobile station. The MSC also delivers the SMS message to an SMS-IWMSC. An acknowledgement message can be sent to the mobile station to indicate successful delivery of the SMS message.

In an alternate embodiment, an SMS message can be successfully delivered when an SGs link in nonoperational by having the mobile station perform a location update.

A mobile station initiates an SMS by sending an SMS message to an eNodeB. The eNodeB passes the SMS message to an MME. The MME checks the SGs association with an MSC. If the SGs association between the MME and the MSC is active at the MME, the MME encapsulates the SMS message and sends the SMS message to the MSC.

In this exemplary embodiment, the SGs association on the MSC between the MME and the MSC is not currently set at the MSC. In typical communication systems, the MSC would ignore the SMS request. In accordance with an exemplary embodiment, the MSC sends an error message to the MME that indicates to the MME that the SGs association on the MSC between the MME and the MSC is not currently set.

Upon receiving the error message at the MME, the MME sets the SGs association at the MME to NULL and also preferably sets an MSC/VLR reliable flag for the mobile station to “FALSE”.

The mobile station sends a Tracking Area Update message, preferably with combined TA/LA (Tracking Area/Location Area) updating. The eNodeB passes the Tracking Area Update message to the MME.

In response to the Tracking Area Update message, the MME sends a Location Update message to the MSC. In response to the Location Update message, the MSC re-registers the mobile station so that the SGs association between the MME and the MSC can be re-established.

SMS messages now sent by the mobile station can be properly delivered because the SGs association between the MME and the MSC at the MSC is properly established.

### BRIEF DESCRIPTION OF THE SEVERAL VIEWS OF THE DRAWINGS

FIG. 1 depicts a portion of a communication system in accordance with an exemplary embodiment of the present invention.

FIG. 2 depicts a flow diagram of a method for delivering an SMS message by re-registering a mobile station in accordance with an exemplary embodiment of the present invention.

FIG. 3 depicts a flow diagram of a method for delivering an SMS message by having a mobile station perform a location update in accordance with an exemplary embodiment of the present invention.

### DETAILED DESCRIPTION OF THE INVENTION

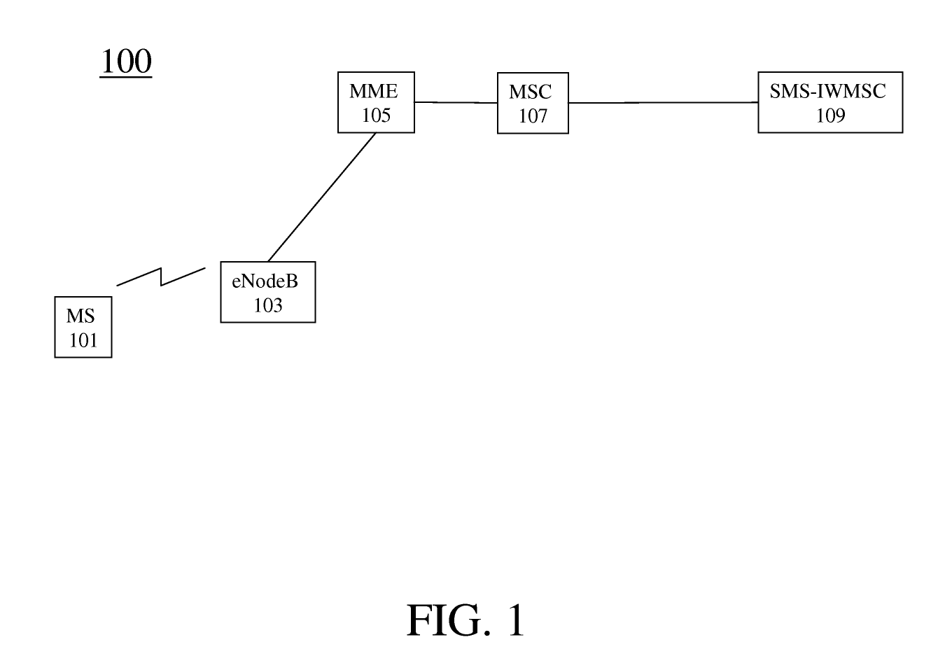

An exemplary embodiment of the present invention can be better understood with reference to FIGS. 1 through 3. FIG. 1 depicts a portion 100 of a communication system in accordance with an exemplary embodiment of the present invention. Portion 100 includes mobile station 101, eNodeB 103, MME 105, MSC 107, and SMS-IWMSC (SMS Interworking MSC) 109.

Mobile station 101 is a device supporting voice and data communication using a wireless air interface. In an exemplary embodiment, mobile station 101 is a Circuit Switch Fall Back (CSFB) mobile station.

eNodeB 103 is an LTE base station that communicates, over the air, with mobile station 101.

MME 105 manages session states, authentication, paging, mobility with SGSN nodes, roaming, and other bearer management functions.

MSC 107 is a Mobile Switching Center. In an exemplary embodiment, MSC 107 comprises a 3G MSC. MSC 107 is the network element that provides voice services and enables mobile terminals to communicate to the Public Switched Telephone Network (PSTN).

SMS-IWMSC 109 is an MSC that is capable of receiving SMS messages from a mobile network and submitting the SMS messages to an appropriate Short Message Service Center (SMSC).

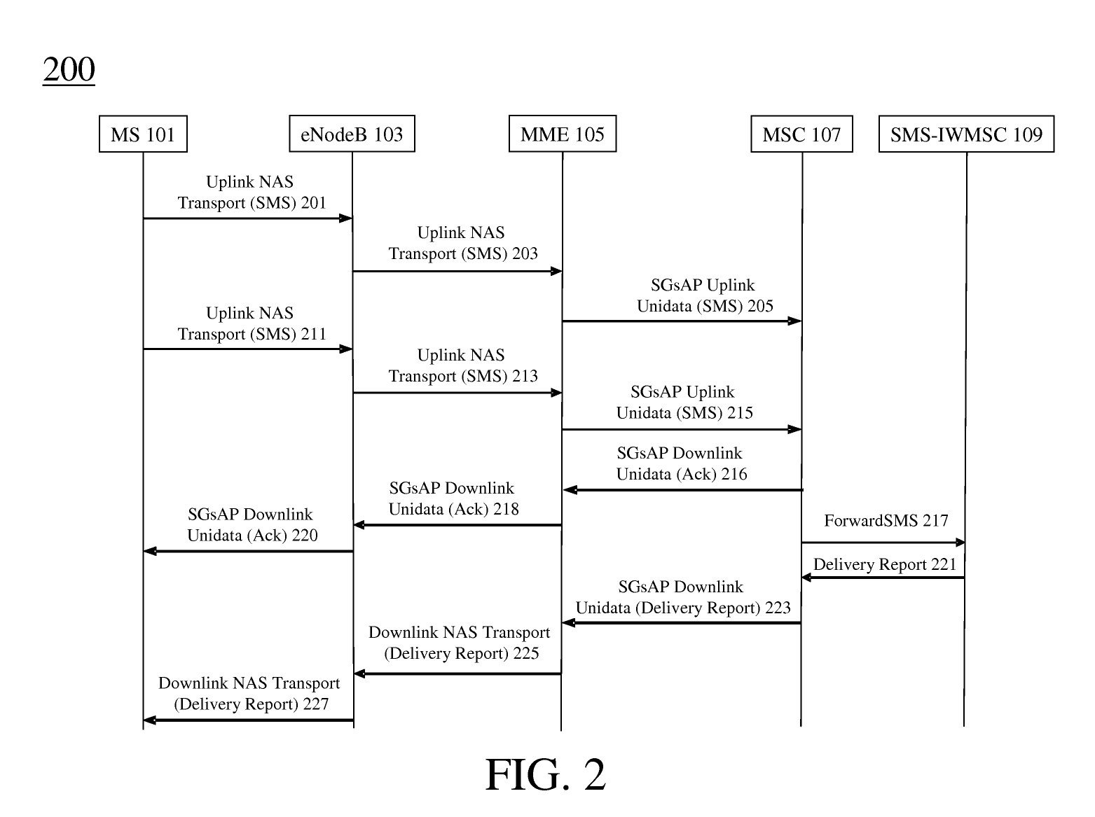

FIG. 2 depicts a flow diagram 200 of a method for re-registering a mobile station 101 in accordance with an exemplary embodiment of the present invention.

Mobile station 101 initiates an SMS message by sending Uplink NAS Transport SMS message 201 to eNodeB 103. In accordance with an exemplary embodiment, mobile station 101 starts a timeout timer.

eNodeB 103 passes Uplink NAS Transport SMS message 201 to MME 105 via Uplink NAS Transport SMS message 203.

MME 105 checks the SGs association with MSC 107. In an exemplary embodiment, the SGs association between MME 105 and MSC 107 is active. MME 105 encapsulates Uplink NAS Transport SMS message 203 in SGsAP Uplink Unidata (SMS) 205 and sends to MSC 107.

In this exemplary embodiment, the SGs association on MSC 107 between MME 105 and MSC 107 is not currently set. In a first exemplary embodiment, this can occur when a VLR record associated with mobile station 101 is deleted, for example due to VLR overload control or other administrative reasons. In a second exemplary embodiment, this can occur when the SGs association is equal to SGs-NULL.

Rather than ignoring the SMS request, as would happen in current communication systems, in accordance with an exemplary embodiment MSC 107 re-registers mobile station 101. The re-registration re-establishes an SGs association between MSC 107 and MME 105.

Upon expiration of the timeout timer, mobile station 101 resends Uplink NAS Transport SMS message 201 as Uplink NAS Transport SMS message 211. Alternately, Uplink NAS Transport SMS message 201 can be stored during registration at MSC 107 and resent by MSC 107 once registration is complete. In this alternate embodiment, mobile station 101 would not need to start a timeout timer or resend Uplink NAS Transport SMS message 201, which saves bandwidth on the network.

eNodeB 103 passes Uplink NAS Transport SMS message 211 to MME 105 via Uplink NAS Transport SMS message 213.

MME 105 encapsulates Uplink NAS Transport SMS message 213 in SGsAP Uplink Unidata (SMS) message 215 and sends to MSC 107.

MSC 107 checks the SGs association. Since MSC 107 re-registered mobile station 101 and re-established an SGs association, MSC 107 acknowledges the receipt of SGsAP Uplink Unidata (SMS) message 215 with a SGsAP Downlink Unidata (Ack) message 216. MME 105 passes the acknowledgement to eNodeB 103 via Downlink Unidata (Ack) message 218. eNodeB 103 passes the acknowledgement to MS 101 via SGsAP Downlink Unidata (Ack) message 220. MSC 107 also delivers SGsAP Uplink Unidata (SMS) message 215 to SMS-IWMSC 109 as ForwardSMS message 217.

SMS-IWMSC 109 sends Delivery Report message 221 to MSC 107.

MSC 107 sends SGsAP Downlink Unidata (Delivery Report) message 223 to MME 105.

MME 105 sends Downlink NAS Transport (Delivery Report) message 225 to eNodeB 103.

eNodeB 103 sends Downlink NAS Transport (Delivery Report) message 227 to mobile station 101.

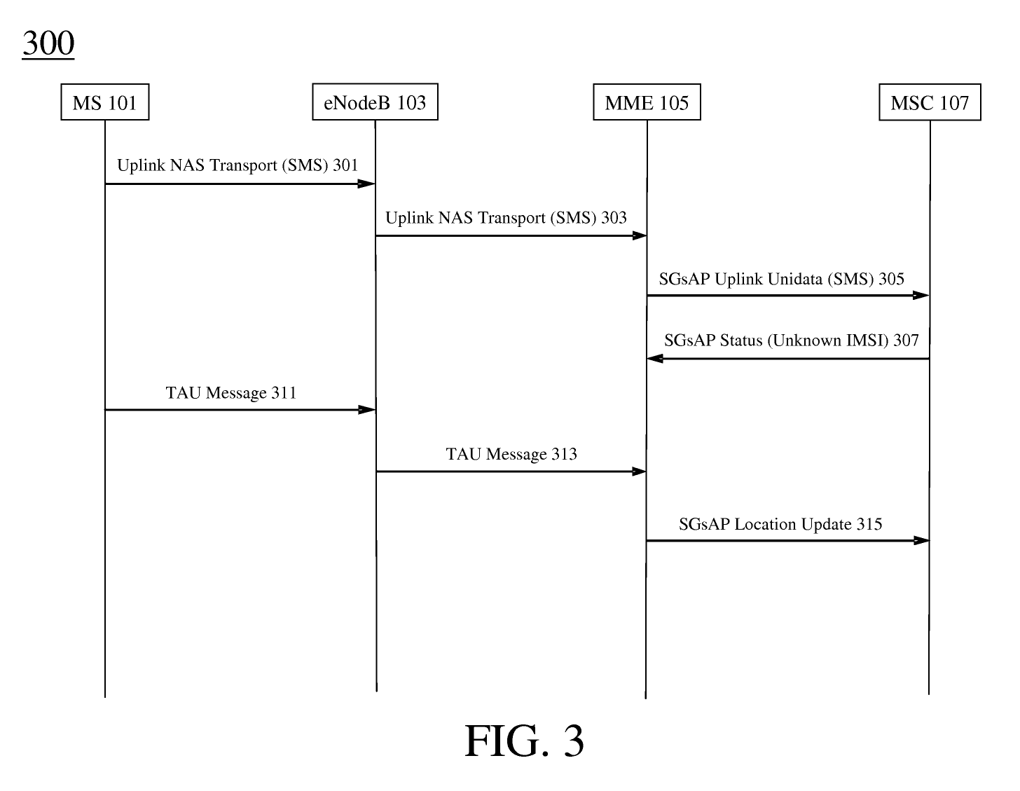

FIG. 3 depicts a flow diagram 300 of a method for delivering an SMS message by having mobile station 101 perform a location update in accordance with an exemplary embodiment of the present invention.

Mobile station 101 initiates an SMS by sending Uplink NAS Transport SMS message 301 to eNodeB 103.

eNodeB 103 passes Uplink NAS Transport SMS message 201 to MME 105 via Uplink NAS Transport SMS message 303.

MME 105 checks the SGs association with MSC 107. In an exemplary embodiment, the SGs association between MME 105 and MSC 107 is active. MME 105 encapsulates Uplink NAS Transport SMS message 303 in SGsAP Uplink Unidata (SMS) 305 and sends to MSC 107.

In this exemplary embodiment, the SGs association on MSC 107 between MME 105 and MSC 107 is not currently set. In a first exemplary embodiment, this can occur when a VLR record associated with mobile station 101 is deleted, for example due to VLR overload control or other administrative reasons. In a second exemplary embodiment, this can occur when the SGs association is equal to SGs-NULL.

In typical communication systems, MSC 107 would ignore the SMS request. In accordance with an exemplary embodiment, MSC 107 sends an error message, SGsAP Status (Unknown IMSI) message 307, to MME 105. Message 307 indicates to MME 105 that the SGs association on MSC 107 between MME 105 and MSC 107 is not currently set.

Upon receiving SGsAP Status (Unknown IMSI) message 307 at MME 105, MME 105 sets the SGs association at MME 105 to NULL. MME 105 also preferably sets an MSC/VLR reliable flag for mobile station 101 to “FALSE”.

In accordance with an exemplary embodiment, mobile station 101 sends a TAU (Tracking Area Update) message 311, preferably with combined TA/LA (Tracking Area/Location Area) updating.

eNodeB 103 passes TAU message 311 to MME 105 via TAU message 313.

In response to TAU message 313, MME 105 sends a SGsAP Location Update message 315 to MSC 107. In response to SGsAP Location Update message 315, MSC 107 re-registers mobile station 101 so that the SGs association between MME 105 and MSC 107 can be re-established.

In accordance with an exemplary embodiment, when an SMS message is now sent by mobile station 101, the SGs association between MME 105 and MSC 107 is properly established so that the SMS message can be properly delivered.

While this invention has been described in terms of certain examples thereof, it is not intended that it be limited to the above description, but rather only to the extent set forth in the claims that follow.

We claim:

1. A method for delivering a short message service (SMS) message, the method comprising:
receiving at a Mobile Switching Center (MSC) an SMS message from a mobile station;
if a link between the MSC and an MME is not currently set for the mobile station, re-registering the mobile station at the MSC;
receiving at the MSC a second SMS message from the mobile station; and
delivering the second SMS message.

2. A method for delivering a short message service (SMS) message in accordance with claim 1, wherein the link is an SGs association.

3. A method for delivering a short message service (SMS) message in accordance with claim 2, wherein the SGs association is Null.

4. A method for delivering a short message service (SMS) message in accordance with claim 3, wherein the SGs association is NULL because a mobile VLR record associated with the mobile station was deleted.

5. A method for delivering a short message service (SMS) message in accordance with claim 1, wherein the step of receiving at a Mobile Switching Center (MSC) an SMS message from a mobile station comprises encapsulating, by the MME, the SMS message in an Uplink-Unidata message prior to sending to the MSC.

6. A method for delivering a short message service (SMS) message in accordance with claim 1, wherein the step of re-registering the mobile station at the MSC comprises establishing an SGs association between the MSC and the MME.

7. A method for delivering a short message service (SMS) message in accordance with claim 1, wherein the step of delivering the second SMS message comprises delivering the second SMS message to a Short Message Service Center (SMSC).

8. A method for delivering a short message service (SMS) message in accordance with claim 1, wherein the step of delivering the second SMS message comprises delivering the second SMS message to an SMS-IWMSC (SMS Interworking MSC).

9. A method for delivering a short message service (SMS) message in accordance with claim 1, wherein the step of receiving at the MSC a second SMS message from the mobile station comprises receiving the second SMS message upon the expiration of a timer.

10. A method for re-establishing an association between a Mobile Switching Center (MSC) and an MME, the method comprising:
receiving at a Mobile Switching Center (MSC) an SMS message from a mobile station;
if a link between the MSC and an MME is not currently set for the mobile station, sending an alert request from the MSC to the MME;
setting a link at the MME to NULL;
receiving a tracking area update message from the mobile station; and
re-registering the mobile station at the MSC.

11. A method for re-establishing an association between a Mobile Switching Center (MSC) and an MME in accordance with claim 10, wherein the link is an SGs association.

12. A method for re-establishing an association between a Mobile Switching Center (MSC) and an MME in accordance with claim 10, the method further comprising the step of sending a location update from the MME to the MSC.

13. A method for re-establishing an association between a Mobile Switching Center (MSC) and an MME in accordance with claim 10, the method further comprising the step of receiving at the MSC a second SMS message from the mobile station.

14. A method for re-establishing an association between a Mobile Switching Center (MSC) and an MME in accordance with claim 10, the method further comprising the step of delivering the second SMS message.

15. A method for re-establishing an association between a Mobile Switching Center (MSC) and an MME in accordance with claim 10, wherein the step of sending an alert request from the MSC to the MME comprises sending the alert request with an unknown IMSI error.

16. A method for re-establishing an association between a Mobile Switching Center (MSC) and an MME in accordance with claim 10, the method further comprising the step of setting a reliability flag at the MME to “false” for the mobile station.

17. A method for re-establishing an association between a Mobile Switching Center (MSC) and an MME in accordance with claim 10, wherein the step of determining if a link between the MSC and an MME is not currently set for the mobile station comprises determining that a VLR record associated with the mobile station has been deleted.

18. A method for re-establishing an association between a Mobile Switching Center (MSC) and an MME in accordance with claim 10, wherein the step of determining if a link between the MSC and an MME is not currently set for the mobile station comprises determining that an SGs association is equal to SGs-NULL.

19. A method for re-establishing an association between a Mobile Switching Center (MSC) and an MME in accordance with claim 10, wherein the tracking area update message comprises TA/LA (Tracking Area/Location Area) updating information.

20. A method for delivering a short message service (SMS) message, the method comprising:
receiving at a Mobile Switching Center (MSC) an SMS message from a mobile station;
storing the SMS message at the MSC;
if a link between the MSC and an MME is not currently set for the mobile station, re-registering the mobile station at the MSC; and
delivering the second SMS message upon successful re-registration of the mobile station.
